(19) United States
(12) Patent Application Publication
(10) Pub. No.: US 2019/0235186 A1
(43) Pub. Date: Aug. 1, 2019

(54) OPTICAL INTERCONNECT FOR SWITCH APPLICATIONS

(71) Applicant: Kaiam Corp., Newark, CA (US)

(72) Inventors: John Heanue, Boston, MA (US); Bardia Pezeshki, Menlo Park, CA (US); Charles Amsden, Fremont, CA (US); Lucas Soldano, Milan (IT)

(21) Appl. No.: 16/121,487

(22) Filed: Sep. 4, 2018

Related U.S. Application Data
(63) Continuation of application No. 15/192,890, filed on Jun. 24, 2016, now abandoned.
(60) Provisional application No. 62/184,685, filed on Jun. 25, 2015.

(51) Int. Cl. G02B 6/42; G02B 6/43

(52) U.S. Cl. CPC G02B 6/4269; G02B 6/43; G02B 6/12021; G02B 6/4285; G02B 6/4274

(57) ABSTRACT

A switch module includes a switch integrated circuit (IC), a silicon photonics chips, and a planar lightwave circuits (PLCs).

### CROSS REFERENCE TO RELATED APPLICATION

This application claims the benefit of the filing date of U.S. Provisional Patent Application No. 62/184,685, filed on Jun. 25, 2015, the disclosure of which is incorporated by reference herein.

### BACKGROUND OF THE INVENTION

The present application relates generally to fiber optic communications and more particularly to switching devices having fiber optic connections.

Much of our cloud based infrastructure is based on storage and processing of data by large numbers of servers in data centers. These servers are connected through a switch network in various configurations. A typical topology might be large groups of 96 servers in a rack connected to a top of rack (TOR) switch. These TOR switches are connected to an aggregation or leaf switch, which in turn is connected to a spine switch. The spine switches are interconnected to form a huge network where every server can connect with every other up and down various links in the system. Generally, with current technology, the servers are connected to the top of rack switch with 10 Gb/s Ethernet copper links, while the spine switches are connected to each other with 40 Gb/s or 100 Gb/s fiber optics. As datacenters are becoming larger and speeds are increasing, there is a trend in interconnects from active optical cable and multimode fiber to single mode fiber that has higher performance.

The switch modules themselves are relatively simple in principle. At their core there is one or more high speed switch ICs that move packets of data based on their address from one lane to another. The latest generation high performance switch ICs may have 128 lanes of 25 Gb/s in each lane, composing 3.2 Tb of data flowing in and out of a central switch IC. Data enters and exits the switch modules through a front panel via optical transceivers, with typically each fiber carrying 40 Gb/s or 100 Gb/s in 4 wavelength lanes of 4×10 Gb/s or 4×25 Gb/s. These transceivers generate or receive optical signals, and, especially those running at higher speeds, may include clock and data recovery (CDR) circuits that regenerate the signals. The transceivers are connected to the central switch IC using electrical links that are routed on a main board and up into an electronics package of the switch IC. Since high speed signals degrade rapidly during only a few inches of travel, CDRs may be used repeatedly in electrical interconnects. The switch chip itself generally includes CDRs as well. Moreover, the CDRs may also require use of equalization circuits to provide signal conditioning prior to clock and/or data recovery. Given the large number of lanes, the interconnect density and power consumption of the module can be a bottleneck to the system.

FIG. 1B shows a front 155 of a switch enclosure. The switch enclosure will generally include a switch IC, generally in a large heatsink. Power consumption can be around 200 W for this IC, so it generally requires a large heatsink and good airflow. The switch enclosure generally also includes power supplies and fans for cooling. As may be seen in FIG. 1B, the front panel is covered almost entirely with sockets 151a-n for optical transceivers, and may also include sockets 153 for other purposes. The cost of the optical transceivers can be substantial and sometimes even more costly than the switch. Switch vendors are typically gated by front panel density of these transceivers, and depending on whether the switch is used for top-of-rack, leaf, or spine, the number of ports can be anywhere from a few to hundreds. Note that the front panel of the switch module is covered entirely with transceivers.

As the switch ICs improve in performance, the switch modules are even more limited by the constraints of the architecture. Current switch ICs with 128 lanes of 25 Gb/s may double to 256 lanes of 25 Gb/s, that may in turn double to 256 lanes of 50 Gb/s, presumably each 50 Gb/s lane actually running at 25 Gigabauds but using advanced PAM4 modulation that doubles the bandwidth. As the number of lanes and modulation speeds increase, generally so does a need for equalization and power consumption.

Thus the conventional switch is seriously limited by the architecture of a central switch IC connected to optical transceivers in the front panel, and the constraints are increasing with newer generations of switches. These constraints may include:
Cost of the optical transceivers.
Power consumption, where perhaps 30%-50% of the total power is expended in equalizing/regenerating electrical signals as data is transferred back and forth from the switch IC and in/out of the transceivers. A considerable amount of power may be consumed by the optical transceivers on the front panel, where airflow is often restricted.
Panel density—the size of the transceivers is such that one can only get a limited number on the front panel and thus only a limited bandwidth out of the front panel of the switch.

### BRIEF SUMMARY OF THE INVENTION

Aspects of the invention provide a switch module comprising: a switch integrated circuit (IC) chip including a switch for routing inputs to outputs of the switch IC chip; a silicon photonics chip including photodetectors for use in converting first optical signals to first electrical signals and modulators for modulating second optical signals in accordance with second electrical signals, outputs of the photodetectors being coupled to inputs of the switch IC chip and outputs of the switch IC chip being coupled to the modulators; a planar lightwave circuit (PLC) optically coupled to the photodetectors and modulators of the silicon photonics chip.

Aspects of the invention provide a switch module comprising: a switch integrated circuit (IC) configured to receive and transmit electrical signals, with the electrical signals routed between various inputs and outputs of the switch IC; a silicon photonics chip coupled to the switch IC, the silicon photonics IC configured to convert optical signals to electrical signals provided to the switch IC and to modulate light from a light source based on electrical signals received from the switch IC; a planar lightwave circuit (PLC) chip comprising: a plurality of first waveguides, each configured to receive light from at least one of a plurality of light sources and output the at least one of the plurality of light sources to the silicon photonics chip; and a multiplexer having a plurality of inputs and an output, the multiplexer configured to produce an optical signal on a wavelength selective basis using modulated light provided by the silicon photonics chip.

Some embodiments in accordance with aspects of the invention provide a switch package, comprising: a central package comprising: a switch integrated circuit (IC) chip including a switch for routing electrical inputs to electrical outputs of the switch IC chip, and a plurality of optical/electrical (OE) conversion modules to convert input optical signals to the electrical inputs of the switch IC chip and to convert the electrical outputs of the switch IC chip to output optical signals; and a plurality of fiber links for carrying optical signals coupling the OE conversion modules to a front panel of a switch enclosure.

These and other aspects of the invention are more fully comprehended upon review of this disclosure.

### BRIEF DESCRIPTION OF THE FIGURES

Aspects of the disclosure are illustrated by way of examples.

FIG. 1A is a block diagram of a switch module in accordance with aspects of the invention.

FIG. 1B (prior art) shows a switch enclosure with a switch IC and with sockets for optical transceivers.

FIG. 2 illustrates a switch package comprising a switch IC and optical modules in accordance with aspects of the invention.

FIG. 3 shows the architecture using a silicon photonics IC that has built in modulators and a receiver, together with the electronics.

FIG. 4 shows an angle polished PLC that is directly connected to an MTP or arrayed fiber connector.

FIG. 5 shows a quad architecture where four lasers are coupled into an array of four assemblies somewhat similar to the previously described architecture.

FIG. 6 shows a potential routing on the PLC.

FIG. 7 shows the complete assembly of 8 modules, each running with 16 lanes of 400 Gb/s packages together with the switch IC.

FIG. 8A illustrates a PLC that includes backup lasers in accordance with aspects of the invention that has electro-optical switches.

FIG. 8B illustrates a PLC that includes backup lasers in accordance with aspects of the invention that does not require electro-optical switches, but uses splitters with multiple inputs.

FIG. 9 illustrates a PLC that can provide the feedback necessary for locking wavelength of lasers in accordance with aspects of the invention.

FIG. 10 illustrates gain chips coupled to a PLC in accordance with aspects of the invention.

### DETAILED DESCRIPTION

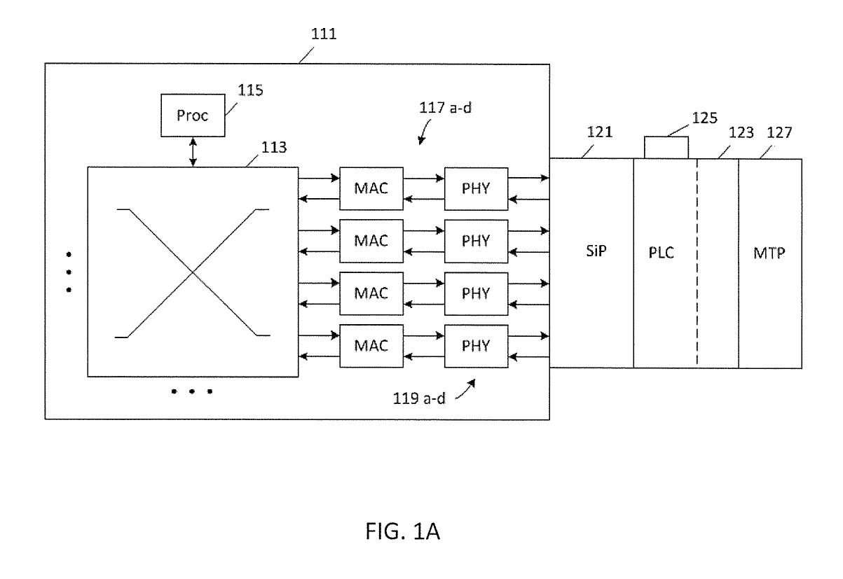

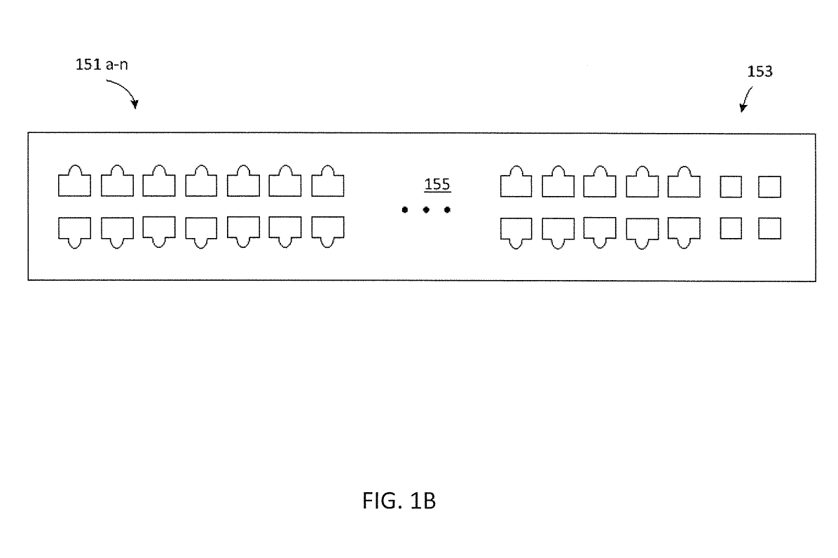

FIG. 1A is a block diagram of a switch module in accordance with aspects of the invention. The switch module includes a switch IC chip 111, a silicon photonics chip 121, and a PLC 123. A light source module 125 is coupled to the PLC, as is a connector 127 for fiber optic lines. The switch IC chip and the silicon photonics chip are electrically coupled so as to pass electrical data between themselves, while the silicon photonics chip and PLC are configured to pass optical data between themselves. The light source module, which for example may include a plurality of lasers or optical gain chips, is also optically coupled to the PLC.

In operation, the switch module receives and transmits optical data over the fiber optic lines. The received optical data is provided to the silicon photonics chip by the PLC, with the silicon photonics chip converting the received optical data to received electrical data. The received electrical data is passed to the switch IC chip, which determines routing of the data, which may include routing of at least some of the data back to the silicon photonics chip as electrical data for transmission. The silicon photonics chip converts the electrical data for transmission to optical data for transmission, using for example light from the light source module, which is provided to the silicon photonics chip by the PLC. The optical data for transmission is passed through the PLC to the connector 127, and sent over the fiber optic lines.

The switch IC chip includes a switch 113, which routes data between switch inputs and switch outputs. The routing of the data is generally controlled by a switch IC chip processor 115, which for example may utilize information of the data, for example in packet headers, as well as routing table maintained by the processor in determining routing of the data between switch inputs and switch outputs.

As illustrated in FIG. 1A, four transmit/receive chains are shown as coupled to the switch 113. In most embodiments, however, many more transmit/receive chains would be coupled to the switch. Similarly, although each transmit/receive chain is shown as including Media Access Control (MAC) circuitry 117a-d and physical layer (PHY) circuitry 119a-d, in various embodiments various buffers, priority queues, and other circuitry may be interposed between the MAC circuitry and the switch.

Also as illustrated in FIG. 1A, only a single silicon photonics chip and PLC pair are explicitly shown, with the four illustrated transmit/receive chains of the switch IC chip providing data to and receiving data from the silicon photonics chip. In most embodiments, however, additional silicon photonics chip and PLC pairs would also be provided.

The switch module itself, in many embodiments, would be within an enclosure, which would also generally include power supplies, cooling fans, potentially a CPU module, and possibly other items. A front panel of the enclosure may also provide connectors for fiber optic lines. In general, however, unlike the situation discussed with respect to FIG. 1B, the front panel would not be equipped with optical transceivers, as the silicon photonics chip and PLC pairs may be considered as generally performing functions which would otherwise be performed by the optical transceivers.

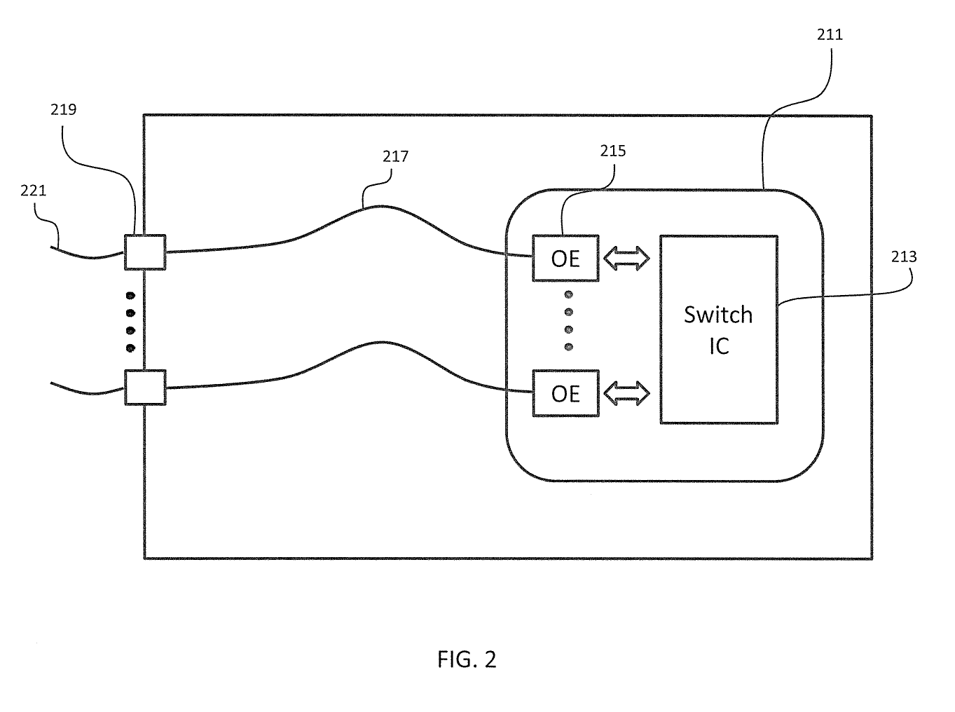

FIG. 2 illustrates a switch package comprising a switch IC and optical modules in accordance with aspects of the invention. A central package 211 contains the optical IC and also contains the optical/electrical (OE) conversion modules 215 that convert the electrical inputs/outputs (I/O) of the switch chip 213 to optical signals. They are cooled by a common central heatsink (not shown) and are connected to the front of the switch with an optical fiber. At the front panel of the switch there is no need for transceivers, since a patch panel 219 connects inside fiber links 217 to outside fiber links 221. Since signals are routed optically from the switch IC to the front panel, there is almost no degradation and, in many embodiments, no need for signal equalization. The electrical link between the IC and the OE modules are very short and therefore may not require reshaping, or in some embodiments retiming. Eliminating these equalization circuits saves considerable amount of power and complexity. In addition, front panel density may be increased since patch panels can be connected very tightly and one can get much denser I/O than when using optical transceiver subassemblies. There is no heat generated in the front panel, where cooling is harder. The OE modules that generate heat, do so at the center of the board where there is room for a large heatsink and good airflow. Since no extra packaging is required for the electronics of the transceivers, and equalization circuitry may often be omitted, and CDR circuitry complexity also possibly reduced, the OE modules are cheaper than transceivers and thus the overall cost of a populated switch is much cheaper with this configuration.

Previously such a configuration was not possible because of certain limitations of optoelectronic devices. The density of electrical signals is very high in and out of the switch IC. If one devotes a single fiber to each electronics lane, one would need many fibers and the solution becomes unwieldy. For example for the previously described switch with 128 lanes of 25 Gb/s, there would be the need for 128 input fibers and 128 output fibers. Fiber optic alignment, especially single mode fiber alignments requires very tight tolerances. This increases the complexity and the packaging cost. One can reduce the number of fibers by using lasers of different wavelengths and multiplexing the different wavelengths into a smaller number of fibers, with each fiber carrying 4 or 8 wavelengths. This reduces the fiber count by the same amount. However, devices used to multiplex wavelengths tend to be either complicated or temperature sensitive. As noted previously, the switch IC generates considerable optical power and therefore temperature could be an issue. An additional issue with temperature is that lasers do not operate well at high temperature, especially lasers that can be modulated at high speed. Placing such lasers on top of the switch IC or in near proximity means the lasers run hot and are therefore inefficient and perhaps slow.

Architectures discussed herein generally route optical signals directly to a switch IC, by way of a silicon photonics chip and considerably simplify the switch in datacenter applications and more generally in electronics where high speed signals are to be routed.

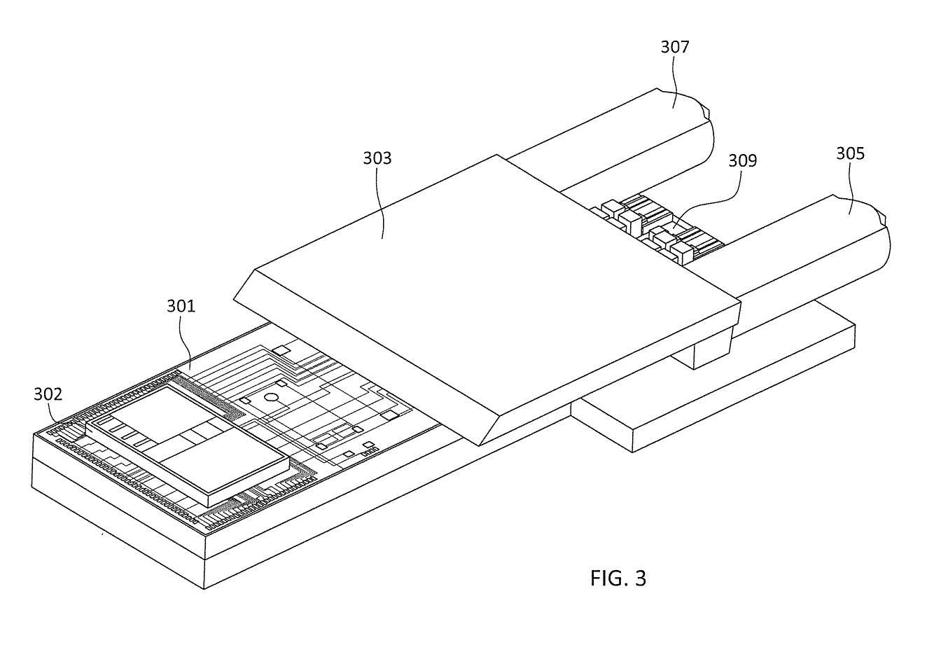

FIG. 3 shows an architecture for optical interconnect applications that includes optical wavelength multiplexers and demultiplexers in a glass PLC and optical modulators in silicon. The architecture uses a silicon photonics IC 301 that has built in modulators and a receiver, together with electronics. The configuration actually includes two separate chips, that are for example bonded together with a copper pillar process. The lower chip is the silicon photonics optical chip that includes grating couplers to allow the light to enter and exit the chip, germanium detectors to receive the input light and modulators to impose a signal on the optical channels for the transmitter. A top chip 302 is an electronics chip that contains amplifiers, drivers and CDRs. The CDRs may or may not be necessary, as that function can be incorporated into the switch IC. As previously mentioned, the electrical link between the assembly of FIG. 3 and the switch IC is quite short, as they are copackaged. So there is limited loss and distortion between this optoelectronic module and the switch IC. In some embodiments, if the electronic chip of the assembly is linear, the CDR can be on the switch IC instead. In this particular embodiment, input data comes in four wavelength lanes through one input fiber 305. The light is demultiplexed by a PLC 303 into four separate waveguides. The PLC is polished at an angle such that the four separate wavelengths in four separate waveguides are reflected downwards into a silicon photonics chip, where there are four grating couplers. These grating couplers send the light into four waveguides into the silicon photonics chip where they are received by germanium photodetectors, which provide electrical signals. The electrical signals are amplified by a TIA, and in some embodiments equalized and clocked by a CDR and exit the silicon photonics chip assembly. For the transmit fiber 307, there are four continuous wave (CW) (or always on) lasers are coupled to four waveguides in the PLC. The light from these waveguides are deflected down by the same angle polish into the silicon photonics chip and enter waveguides in the silicon photonics chip through grating couplers. The light in the four waveguides are then modulated by data signals and exit the chip through grating couplers, once again entering the PLC. The PLC contains a transmit AWG that multiplexes the channels together into a single output, provided to the transmit fiber 307.

This particular architecture is very useful for hybrid integration with silicon ICs. In various embodiments:
The wavelength multiplexer and demultiplexer is made from glass waveguides on a silicon wafer (PLCs). These structures are relatively temperature insensitive and therefore are generally not affected by the high power dissipation from the silicon switch IC.
The lasers are made of Indium Phosphide and are CW lasers, not modulated lasers. Such lasers are also relatively temperature insensitive, compared to modulated lasers or lasers made of composite materials directly on the silicon wafer. In some embodiments the light sources are gain chips using reflective element in the PLC.

The lasers are on a different side and somewhat away from the silicon IC. This allows the lasers to be cooled and keeps the RF signals and DC signals separated.

Connecting fibers to PLCs is a well established technology and can be done easily in an automated manner. Similarly the architecture is well suited to MEMS based alignment for the coupling of lasers 309 to the PLCs. This is an efficient and automated way of coupling light into the PLC.

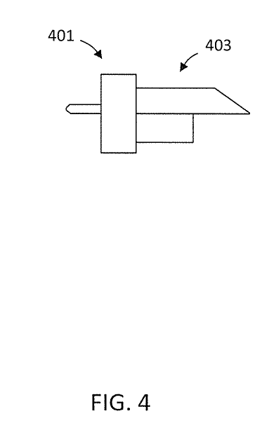

FIG. 4 shows an angle polished PLC 403 that is directly connected to an MTP or arrayed fiber connector 401. The individual cores of fibers in the connector are epoxied to the PLC such that light from those fibers are coupled to the waveguides of the PLC.

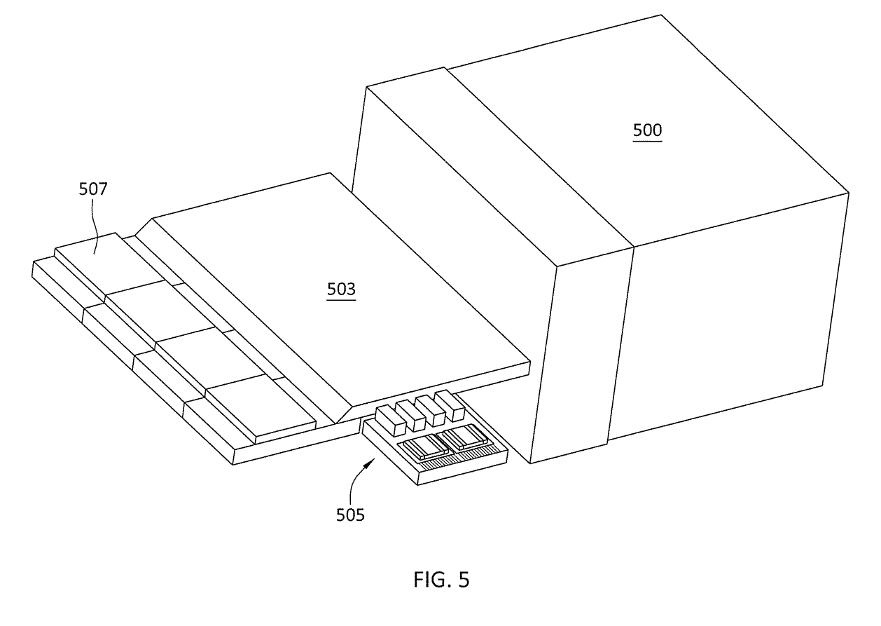

FIG. 5 shows a quad architecture where four lasers are coupled into an array of four assemblies somewhat similar to the previously discussed architecture. Four lasers 505 are coupled to the side of the PLC 503 using MEMS coupling, for example as discussed in U.S. patent application Ser. No. 14/621,273 filed on Feb. 12, 2015 entitled PLANAR LIGHTWAVE CIRCUIT ACTIVE CONNECTOR, and/or U.S. Pat. No. 8,346,037 issued on Jan. 1, 2013 entitled MICROMECHANICALLY ALIGNED OPTICAL ASSEMBLY, the disclosures of which are incorporated herein by reference for all purposes. The signals from the four lasers are routed on the PLC to a quad version of the silicon photonics chip 507 previously discussed. Since each silicon photonics chip modulates four channels, there are 16 different lanes of output. These go into 4 transmit fibers (not shown), each fiber containing four wavelengths. The receive side is similar with 16 lanes entering, broken down into 4 waveguides with 4 wavelengths in each. The MTP connector 500 thus has 4 input waveguides and 4 output waveguides. If each lane is modulated at 25 Gb/s, that yields 400 Gb/s in and out of the assembly.

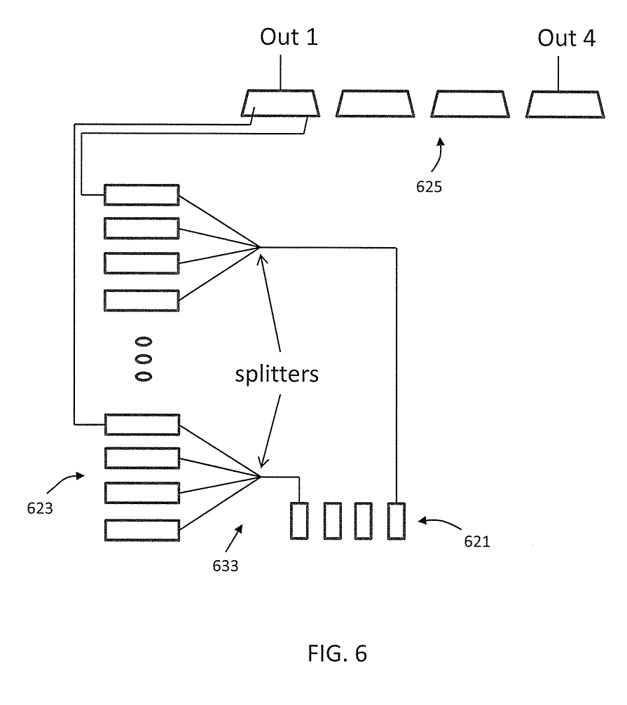

FIG. 6 shows an example routing on the PLC. Light from each of the CW lasers 621 is split into four waveguides 623, with FIG. 6 explicitly showing, as examples, paths for light from two of the lasers each being sent to separate sets of four waveguides, and light from one waveguide of each of those sets eventually being received by a single output waveguide. The light is the coupled into a silicon photonics chips (not shown) where they are modulated, using data signals (not shown) provided to the silicon photonics chips. The modulated light is combined into 4 output waveguides 625, each waveguide containing four wavelengths. Note that there are different configurations possible, but with the same result. For example the splitters could be implemented in the PLC or in the silicon photonics chip. Similarly, the same wavelength could be sent to all four modulators in one chip or all four wavelengths could be sent to all four modulators on one chip. In general, the outputs are sorted such that each waveguide output at the end contains all four wavelengths. In FIG. 6 only the transmit paths are shown, not the receive paths, and only a fraction of the waveguides are shown for simplicity. However, the PLC would contain four splitters 633 to take the light from the 4 CW lasers and break them up into 16 lanes. It would also contain 4 AWGs, or one cyclic AWG to take the 16 modulated channels and combine them into four output waveguides. On the receive side, the PLC would contain four AWGs or a cyclic AWG that would take the 4 inputs each input with 4 wavelengths into 16 channels for the receiver.

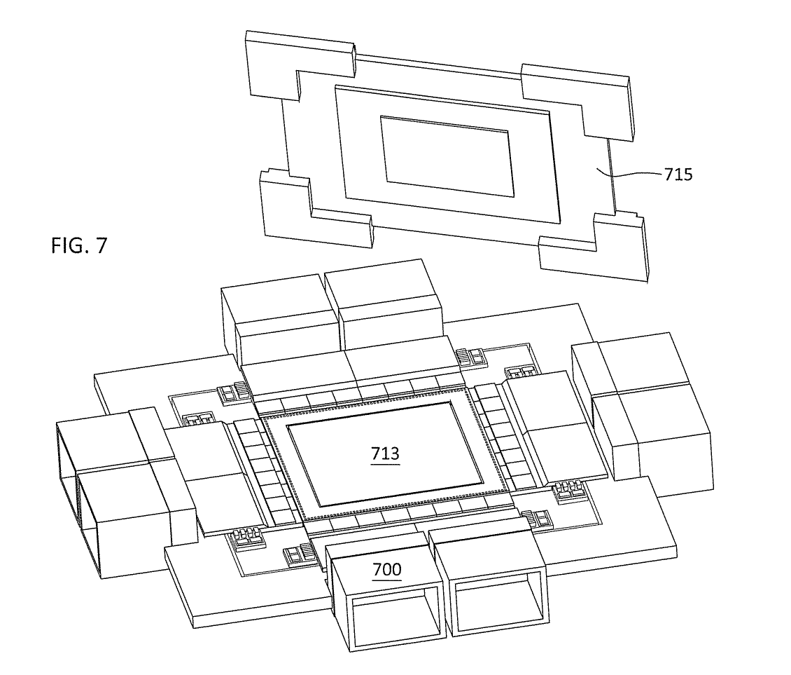

FIG. 7 shows the complete assembly of 8 modules, each running with 16 lanes of 25 Gb/s packaged together with the switch IC 713. This provides 3.2 Tb/s input and output to the switch IC. There are 8 MTP connectors 700, each of which has at least 4 transmit fibers (not shown), 4 receive fibers (not shown), each fiber carrying 100 Gb/s either in or out. These MTP connectors would be connected to the front panel of the switch using fibers. The front panel of the switch would then be simply a patch panel, either with MTP connectors or broken up into 4 separate dual single mode fibers with potentially LC connectors. Note that even though there are 32 input and 32 output fibers and each fiber containing 4 wavelength lanes, that there are only 8 lasers of each wavelength. The lasers are separated somewhat from the switch IC and heatsunk to the metallic base plate. A metallic cover 715 also helps spread the heat, such that the heat from the switch IC is dissipated and the lasers stay relatively cool. As CDRs for signals passed between the silicon photonics modulators and the switch IC in various embodiments do not include or have associated equalization circuits, can be lower performance than generally used for 40 GHz signals (or 10 GHz signals in various embodiments), or in some embodiments be switched off completely or omitted, the overall power consumption is reduced considerably, leading to less heating. With current technology, we expect each 100G module to consume about 1.5 W with no CDRs, such that 32 such modules would consume about 50 W or so. The switch IC would consume about 200 W.

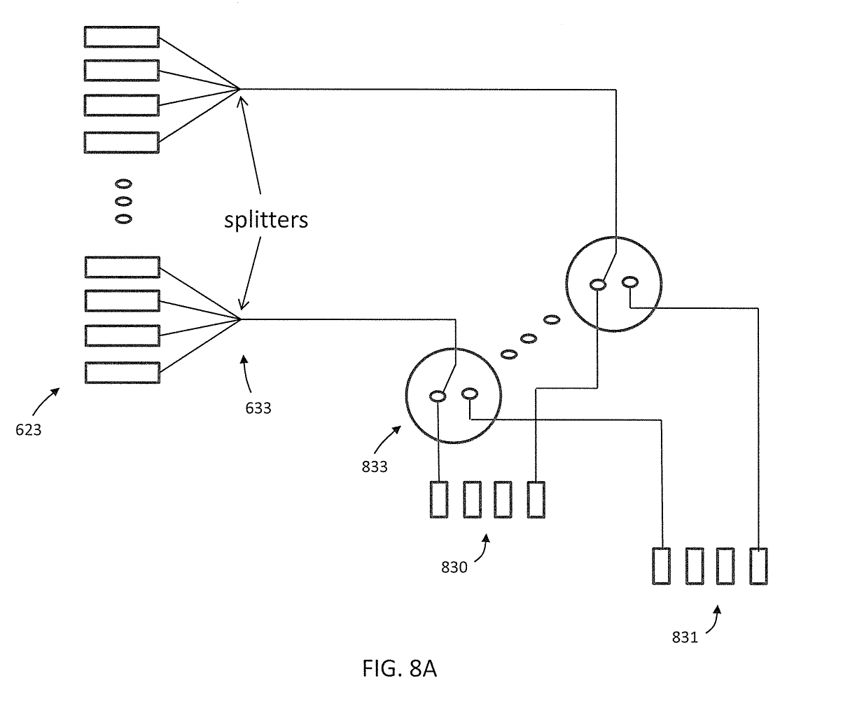

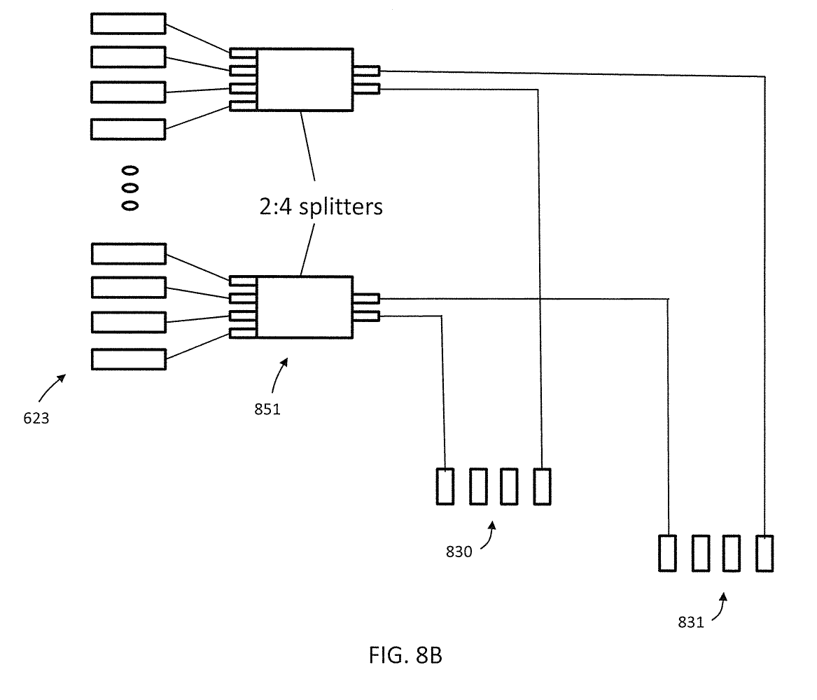

FIGS. 8A and 8B illustrate portions of a PLC that makes use of backup lasers in accordance with aspects of the invention. There are a number of variations in this architecture. For example, for additional reliability, one could insert backup lasers 831 into the system in addition to primary lasers 830. Should a laser fail, the electronics could turn on a backup laser. These backup lasers could be connected to the system with a 3 dB coupler—which would incur an additional 3 dB loss. Alternatively, since the coarse wavelength division multiplexed grid is relatively broad, lasers of slightly different wavelengths could be wavelength multiplexed together with a low loss filter. The lasers would be close enough in wavelength such that either would fit in the same slot in the CWDM band. One option is using optical switches 833 in the PLC that would be much lower loss, but would use active control. Such optical switches can easily be implemented using a thermo-optic directional coupler or Mach-Zehnder architecture. Such a configuration is shown in FIG. 8A. Not shown in the figures are monitor photodiodes that would likely be implemented either in the silicon photonics or as separate elements on the PLCs. These monitor diodes would report if a laser has failed and would direct the electronics control to switch on a backup laser. Implementing the routing for such on the PLC is straightforward.

FIG. 8B illustrates aspects of a variation that also allows backup lasers, but needs no active optical switch, and in most embodiments incurs no additional loss. Compared with the embodiment of FIG. 8A, the embodiment of FIG. 8B replaces the optical switches and single input splitters with multi-input splitters. In FIG. 8A there are splitters that take one laser and split it into four channels, so there is already a 6 dB loss of taking a single output and dividing it into four. Instead of using a 1:4 splitter of FIG. 8A, one could use a multi-input splitter, for example a 2:4 splitter 851 as illustrated in FIG. 8B or even a 4:4 splitter. As illustrated in FIG. 8B, each 2:4 splitter receives light from both one of the primary lasers 830 and one of the backup lasers 830. In this case there is no additional loss to having extra inputs. The loss of a 4:4 splitter, a 2:4 splitter and a 1:4 splitter are identical, ideally at about 6 dB. In this case electronics would detect a laser failure and then activate a backup laser, but there is no need for an optical switch.

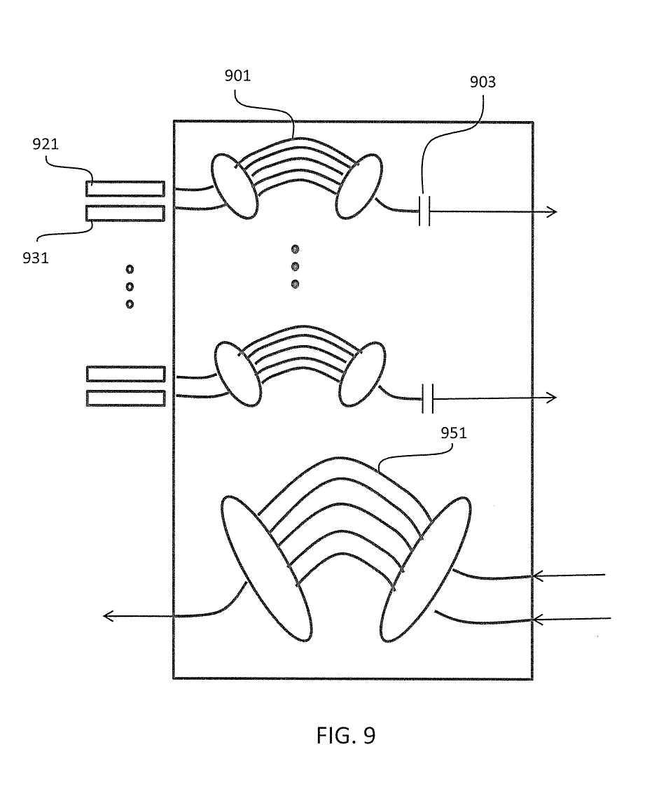

FIG. 9 illustrates aspects of a PLC that can provide feedback for locking wavelength of lasers in accordance with aspects of the invention. The PLC is an excellent platform for integration and in fact the PLC can provide the feedback for locking the wavelength of the lasers. This may make the backup laser option very easy. FIG. 9 shows a schematic of such an implementation. In this case for each channel a primary and a secondary gain chip are coupled to a PLC. The gain chip does not have a grating or reflective facet coating in front, such that the light passes unimpeded from the semiconductor waveguide in to the PLC. The PLC contains a wavelength routing component such as an AWG 901 and at the output of this component there is a reflective element 903. This could be a Bragg grating, or simply a reflective coating (generally partially reflecting) on the PLC facet. Thus the gain chip lases through the PLC. This PLC would have channels that are closely spaced, such that the primary and the secondary gain elements would lase at slightly different wavelengths, but both would be within the passband of the communication channels. Thus if a primary laser 921 fails, perhaps due to degradation in the InP gain element, a secondary channel including laser (or gain element) 931 would be activated. This would be a very slightly different wavelength but within the required band. All the wavelength channels would be backed up this way and the light would enter the silicon photonics chip to be modulated. The modulated channels would exit the silicon photonics chip and be multiplexed together with a second AWG 951, one with wider channel spacings corresponding to the system requirements (for example 20 nm for standard CWDM channels).

Another possibility would be to run both lasers simultaneously, such that each laser is running at a lower power, thus assuring greater reliability—thus there may be no need for backup laser. In fact a number of lasers, for example three, four, or more, can be “spectrally combined” in this way to yield much higher powers if needed for silicon photonics applications. If a larger number of lasers are combined, then the potential failure of a single laser is not catastrophic as it reduces the power by a smaller fraction.

The ability of the PLC to lock the wavelengths of gain elements is a very powerful tool and can be helpful when the number of channels go up and wavelength spacing of the lasers becomes narrower. In general, DFB laser wavelength is set by the grating in the DFB laser, and changes with temperature as the refractive index of the semiconductor changes with temperature at values roughly corresponding to 0.1 nm/C. For data center applications, channels spacings are CWDM or Course wavelength division multiplexed, spaced at 20 nm or so. This allows the lasers to change wavelengths by 80 C or ˜8 nm without overlapping adjacent channels. However, if there is a desire to increase channel numbers from 4 to 16 or more, channel spacing may be reduced. This may necessitate a thermoelectric cooler to stabilize the laser wavelengths. For example there is another wavelength plan LAN-WDM that is 800 GHz or roughly 4.5 nm.

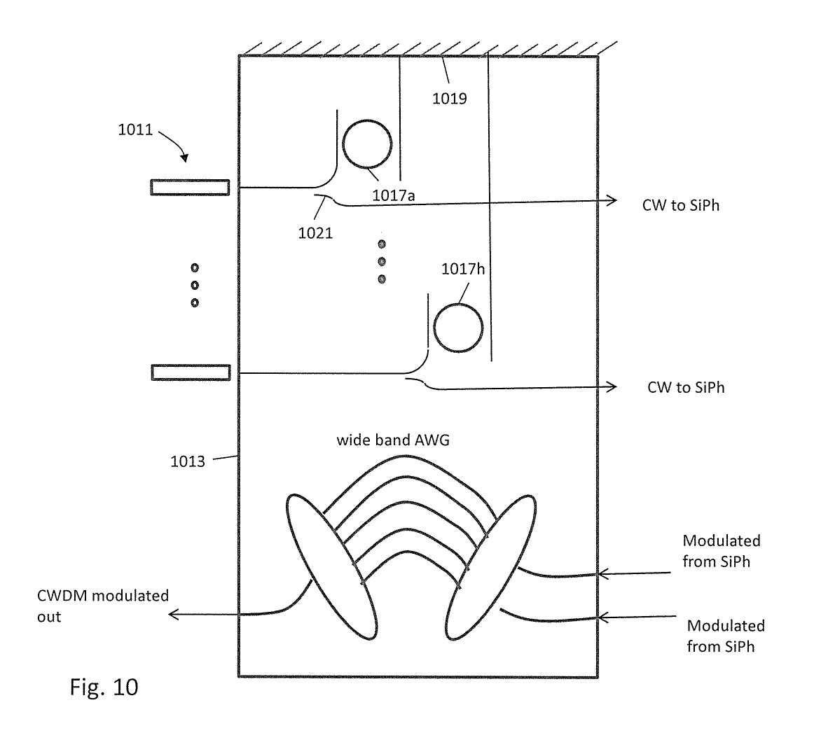

Alternatively one could use a PLC to stabilize the wavelength of a gain chip before coupling it to the silicon modulator. Schematically it may look like FIG. 10. An array of eight gain chips 1011 in the 1310 nm band are coupled to a PLC 1013. Within the PLC there are eight wavelength dependent structures that would feedback a different wavelength to each gain chip. For example these could be ring resonators as shown where the output of the gain chip couples to a ring (e.g. 1017a . . . h), and a single wavelength is transmitted. This transmitted wavelength then routed to a top side 1019 of the PLC chip that is high reflectivity (HR) coated and therefore is reflected back through the ring and back to the gain chip. The gain chip therefore lases through the PLC at the wavelength corresponding to the ring. There is a tap (e.g. 1021) also on the output of the laser that couples power to the output going to the silicon photonics. For an 8 channel system for a 400G application, the wavelengths of the resonators would nominally be 1263.55 nm, 1277.89 nm, 1282.26 nm, 1286.66 nm, 1295.56 nm, 1300.05 nm, 1304.58 nm, 1309.14 nm. However, since the index change of the glass with temperature is only 0.01 nm/C, these would only change 0.8 nm over 80 C, and would be less than 20% of the band difference, therefore no thermoelectric cooler is needed. The light exiting the silicon photonics would enter the PLC again and be multiplexed together as previously described. Of course there are a variety of structures that could be used to get this implementation. Instead of ring resonators one could use AWGs or asymmetric mach-zehnder structures. Reflectors could be a coated side, a Bragg reflector, loop mirror, or reflection from a trench. Rather than a separate tap and reflector, one could use a partial reflector that transmits light to the output as well as reflects light back to enable lasing.

The light sources of FIG. 10 could also have backup lasers as previously described. Alternatively, for higher reliability and the ability to replace failed components, the light source could be external to the entire assembly. The CW sources could be mounted in the front plate, such that if a light source fails, the CW source could easily be replaced. Given that the MTP connectors typically have 12 fibers and four channel systems only use eight fibers (four signal input and four signal output), the extra four fibers could be used as CW laser sources. These external light sources could be simple DFBs or gain chips lasing through a PLC, or even lasers with backup as previously described.

Another simple modification to the design is to replace the MTP connectors with fiber pigtails. In this case each 400G module would have 8 fibers attached to the PLC through a fiber V-groove assembly. These fibers would have connectors that would mate to the front plate. The advantage of such an approach is that it eliminates the connectors on the IC package that can be unreliable and lossy.

Other modifications are that the silicon switch IC could contain all the functionality of the silicon photonics chip. So no separate ICs would be needed. The PLCs would mate directly to the silicon IC, as the switch chip would contain the modulators and receivers.

The configuration described in this patent application is very scalable. One can increase or decrease the number of channels, vary the channel spacing, or change the modulation format. For example, the silicon modulators could be run using PAM4 modulation instead of NRZ—but the physical architecture stays the same.

Although the invention has been discussed with respect to various embodiments, it should be recognized that the invention comprises the novel and non-obvious claims supported by this disclosure.

1. A switch module, comprising:
a switch integrated circuit (IC) chip including a switch for routing inputs to outputs of the switch IC chip;
a silicon photonics chip including photodetectors for use in converting first optical signals to first electrical signals and modulators for modulating second optical signals in accordance with second electrical signals, outputs of the photodetectors being coupled to inputs of the switch IC chip and outputs of the switch IC chip being coupled to the modulators;
a planar lightwave circuit (PLC) optically coupled to the photodetectors and modulators of the silicon photonics chip.

2. The switch module of claim 1, further comprising a plurality of light sources optically coupled to the PLC.

3. The switch module of claim 2, wherein the PLC includes a plurality of splitters for splitting light from each of the light sources into a plurality of waveguides for provision to the silicon photonics chip.

4. The switch module of claim 3, wherein the plurality of light sources include a plurality of primary light sources and a plurality of backup light sources, and the plurality of splitters comprise a plurality of multi-input splitters, with each of the plurality of multi-input splitters configured to receive light from a one of the plurality of primary light sources and a one of the plurality of backup light sources.

5. The switch module of claim 2, wherein the switch IC chip and the plurality of light sources share a common heatsink.

6. The switch module of claim 5, wherein the switch IC chip, the silicon photonics chip, the PLC and the plurality of light sources are contained within an enclosure.

7. The switch module of claim 6, wherein the enclosure includes a front panel, the front panel including sockets to receive optical connections, and wherein at least some of the sockets are coupled to the PLC by optical fiber.

8. The switch module of claim 2, wherein the plurality of light sources comprise lasers.

9. The switch module of claim 2, wherein the plurality of light sources comprise optical gain chips.

10. A switch module comprising:
a switch integrated circuit (IC) configured to receive and transmit electrical signals, with the electrical signals routed between various inputs and outputs of the switch IC;
a silicon photonics chip coupled to the switch IC, the silicon photonics IC configured to convert optical signals to electrical signals provided to the switch IC and to modulate light from a light source based on electrical signals received from the switch IC;
a planar lightwave circuit (PLC) chip comprising:
a plurality of first waveguides, each configured to receive light from at least one of a plurality of light sources and output the at least one of the plurality of light sources to the silicon photonics chip; and
a multiplexer having a plurality of inputs and an output, the multiplexer configured to produce an optical signal on a wavelength selective basis using modulated light provided by the silicon photonics chip.

11. The switch module of claim 10, wherein the PLC further includes a plurality of splitters, each configured to receive light from at least one of the plurality of light sources and to provide the light from the at least one of the plurality of light sources to at least some of the plurality if first waveguides.

12. The switch module of claim 11, wherein the splitters are multi-input splitters, and further comprising a plurality of backup light sources, with each splitter additionally configured to receive light from at least one of the plurality of backup light sources and to provide light from the at least one of the plurality of backup light sources to at least some of the plurality of first waveguides.

13. The switch module of claim 10 further comprising a plurality of optical switches and a plurality of backup light sources, each of the plurality of optical switches configured to couple either one of the plurality of light sources or one of the plurality of backup light sources to a one of the waveguides.

14. The switch module of claim 10 wherein each of the plurality of waveguides includes a wavelength routing component having a reflective element.

15. The planar lightwave circuit of claim 14, wherein the wavelength routing component is an arrayed waveguide grating (AWG).

16. A switch package, comprising:
a central package comprising: a switch integrated circuit (IC) chip including a switch for routing electrical inputs to electrical outputs of the switch IC chip, and a plurality of optical/electrical (OE) conversion modules to convert input optical signals to the electrical inputs of the switch IC chip and to convert the electrical outputs of the switch IC chip to output optical signals; and
a plurality of fiber links for carrying optical signals coupling the OE conversion modules to a front panel of a switch enclosure.
